(19) United States
(12) Patent Application Publication
(10) Pub. No.: US 2015/0257056 A1
(43) Pub. Date: Sep. 10, 2015

(54) PARALLEL RANK BASED AND PRIORITY BASED CELL RESELECTION

(71) Applicant: QUALCOMM Incorporated, San Diego, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, San Diego, CA (US)

(21) Appl. No.: 14/198,502

(22) Filed: Mar. 5, 2014

(51) Int. Cl. H04W 36/00

(52) U.S. Cl. CPC H04W 36/0083; H04W 36/36

(57) ABSTRACT

A user equipment (UE) reselects to a higher priority cell even when a cell reselection timer of a low priority cell and/or rank based cell expires before a cell reselection timer of the higher priority cell. In one instance, the UE determines an expiration of a first cell reselection timer for the low priority cell and/or an expiration of a second cell reselection timer for the rank based cell while a third cell reselection timer is running, but not expired. The third cell reselection timer corresponds to the high priority based cell. The UE delays performing cell reselection to the low priority or rank based cell until the high priority based cell is evaluated, even when a cell reselection condition has been stratified for the low priority or rank based cell.

### BACKGROUND

1. Field

Aspects of the present disclosure relate generally to wireless communication systems, and more particularly, to parallel rank and priority based cell reselection.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes determining a first timer expired for a low priority based cell and/or a second timer expired for a rank based cell while a third timer is running, but not expired. The third timer corresponds to a high priority based cell. The method also includes delaying cell reselection to the low priority based cell or the rank based cell while the third timer is still running and when a cell reselection trigger condition is satisfied for the low priority based cell and/or rank based cell.

According to another aspect of the present disclosure, an apparatus for wireless communication includes means for determining a first timer expired for a low priority based cell and/or a second timer expired for a rank based cell while a third timer is running, but not expired. The third timer corresponds to a high priority based cell. The apparatus also includes means for delaying cell reselection to the low priority based cell or the rank based cell while the third timer is still running and when a cell reselection trigger condition is satisfied for the low priority based cell and/or rank based cell.

According to yet another aspect of the present disclosure, an apparatus for wireless communication includes a memory and at least one processor coupled to the memory. The processor(s) is configured to determine a first timer expired for a low priority based cell and/or a second timer expired for a rank based cell while a third timer is running, but not expired. The third timer corresponds to a high priority based cell. The processor(s) is also configured to delay cell reselection to the low priority based cell or the rank based cell while the third timer is still running and when a cell reselection trigger condition is satisfied for the low priority based cell and/or rank based cell.

According to a still further aspect of the present disclosure, a computer program product for wireless communication in a wireless network includes a computer readable medium having non-transitory program code recorded thereon. The program code includes program code to determine a first timer expired for a low priority based cell and/or a second timer expired for a rank based cell while a third timer is running, but not expired. The third timer corresponds to a high priority based cell. The program code also includes program code to delay cell reselection to the low priority based cell or the rank based cell while the third timer is still running and when a cell reselection trigger condition is satisfied for the low priority based cell and/or rank based cell.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a block diagram illustrating a parallel rank and priority based cell reselection method according to one aspect of the present disclosure.

FIG. 6 is a block diagram illustrating a reselection method according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

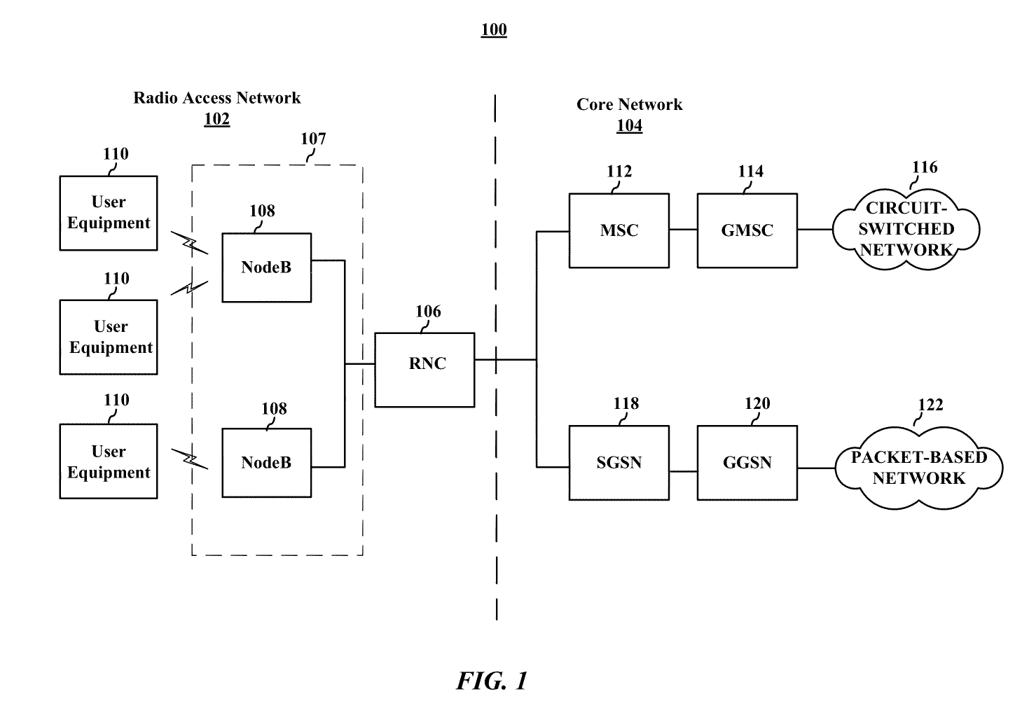

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

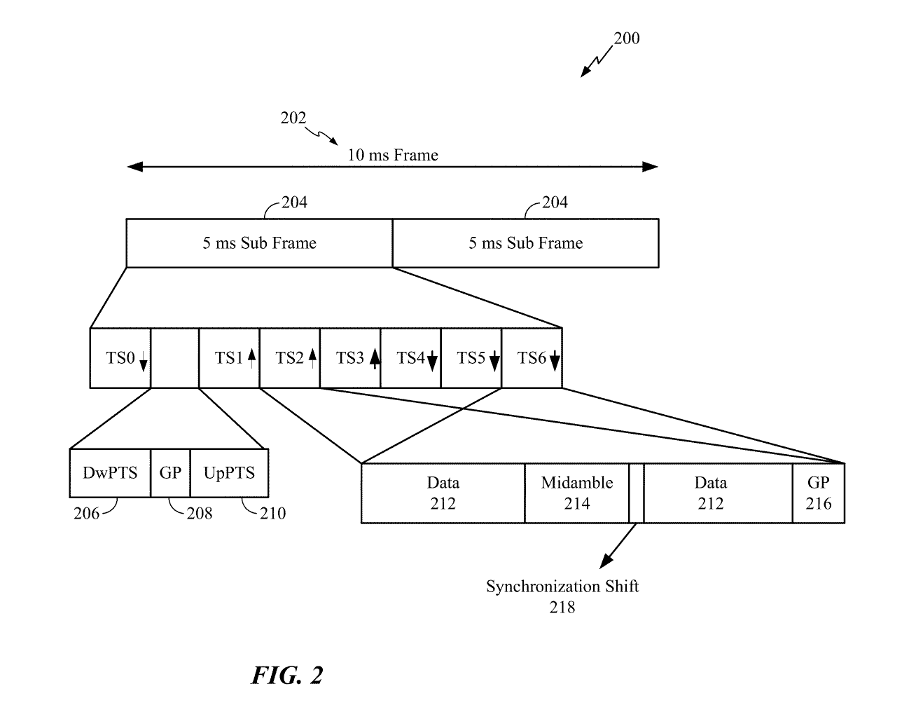

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

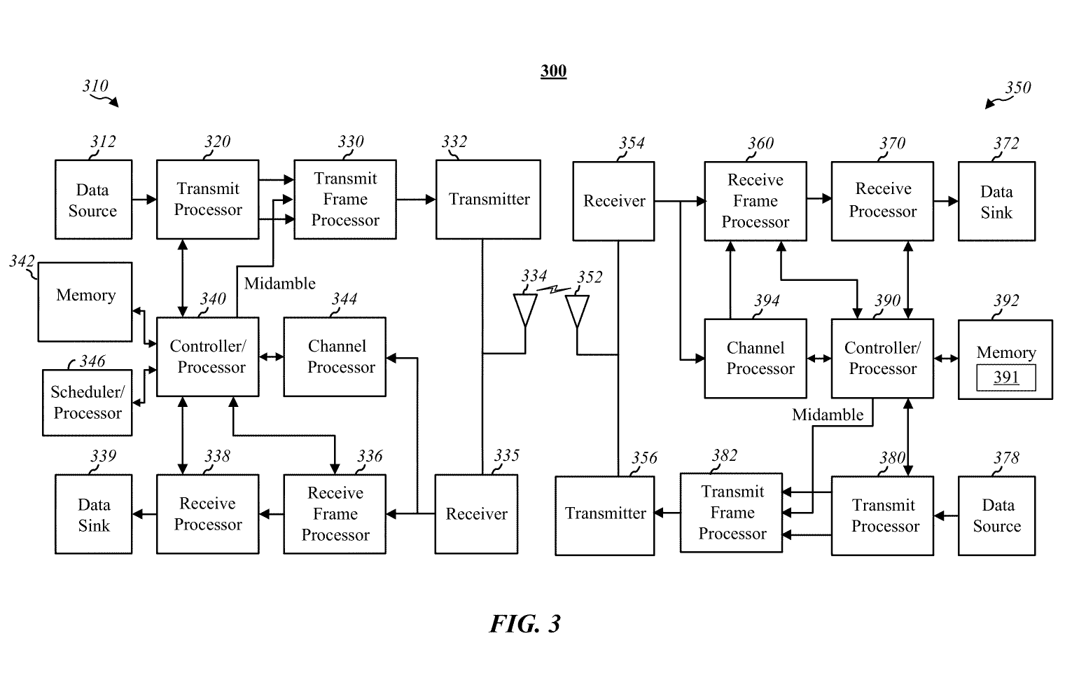

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a parallel reselection module 391 which, when executed by the controller/processor 390, configures the UE 350 to implement cell a reselection method according to aspects of the present disclosure. A scheduler/processor 346 at the node B 310 may be used to allocate resources to the UEs and schedule downlink and/or uplink transmissions for the UEs.

Certain UEs may be capable of communicating on multiple radio access technologies (RATs). Such UEs may be referred to as multimode UEs. For example, a multimode UE may be capable of communications on a Universal Terrestrial Radio Access (UTRA) frequency division duplexed (FDD) network such as a Wideband-Code Division Multiple Access (W-CDMA) network, a UTRA time division duplexed (TDD) network such as a Time Division-Synchronous Code Division Multiple Access (TD-SCDMA) network, Global System for Mobile Communications (GSM) and/or a Long Term Evolution (LTE) network.

Some networks, such as a newly deployed network, may cover only a portion of a geographical area. Another network, such as an older more established network, may better cover the area, including remaining portions of the geographical area. In areas where a first network utilizing a first radio access technology (e.g., TD-SCDMA) is deployed, a second network utilizing a second radio access technology (e.g., Global System for Mobile Communications (GSM) or wideband code division multiple access (WCDMA) may also have a geographical presence.

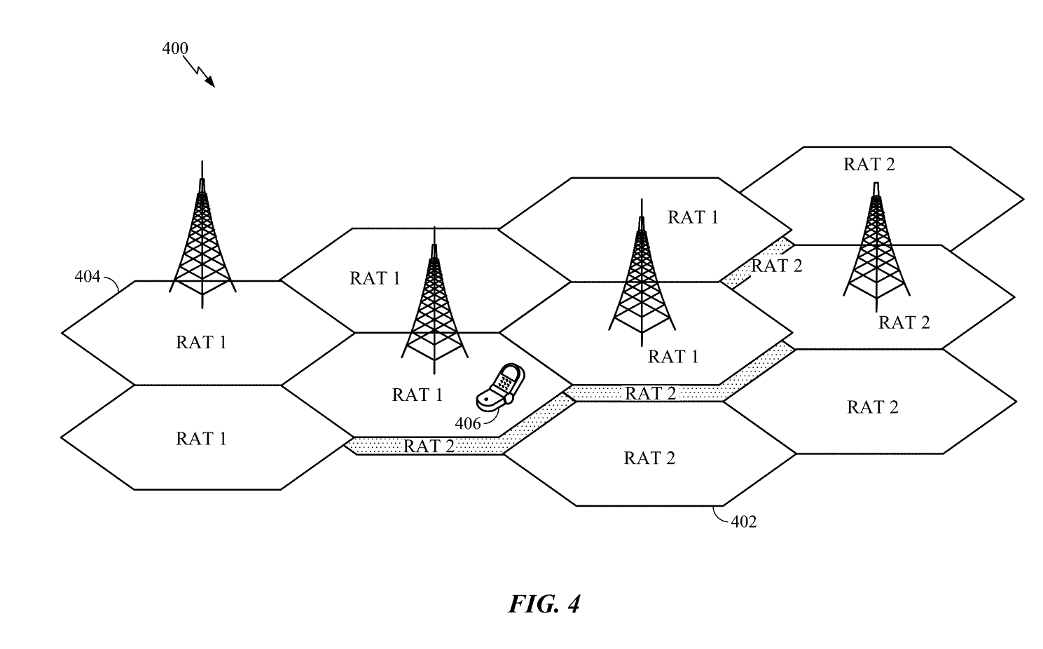

FIG. 4 illustrates coverage of a newly deployed network utilizing a first type of radio access technology (i.e., RAT-1), such as a TD-SCDMA network, and also coverage of an established network utilizing a second type of radio access technology (i.e., RAT-2), such as a GSM network. In this deployment of a network, a user equipment (UE) may be in the vicinity of the first RAT but continue to perform inter-radio access technology (inter-RAT) measurement of the second RAT. This measurement may be implemented for a cell or base station reselection procedure from the first RAT to the second RAT.

The geographical area 400 includes RAT-1 cells 404 and RAT-2 cells 402. In one example, the RAT-1 cells are TD-SCDMA cells and the RAT-2 cells are GSM cells. However, those skilled in the art will appreciate that other types of radio access technologies may be utilized within the cells. A user equipment (UE) 406 may move from one cell, such as a RAT-1 cell 404, to another cell, such as a RAT-2 cell 402. The movement of the UE 406 may specify a handover or a cell reselection.

Handover or cell reselection from a first radio access technology (RAT) to a second RAT may occur for several reasons. First, the network may prefer to have the user equipment (UE) use the first RAT as a primary RAT but use the second RAT simply for voice service(s). Second, there may be coverage holes in the network of one RAT, such as the first RAT.

Handover or cell reselection from the first RAT to the second RAT may be based on event 3A measurement reporting. In one configuration, the event 3A measurement reporting may be triggered based on filtered measurements of the first RAT and the second RAT, a base station identity code (BSIC) confirm procedure of the second RAT and also a BSIC re-confirm procedure of the second RAT. For example, a filtered measurement may be a Primary Common Control Physical Channel (P-CCPCH) or a Primary Common Control Physical Shared Channel (P-CCPSCH) received signal code power (RSCP) measurement of a serving cell. Other filtered measurements can be of a received signal strength indication (RSSI) of a cell of the second RAT.

The initial BSIC identification procedure occurs because there is no knowledge about the relative timing between a cell of the first RAT and a cell of the second RAT. The initial BSIC identification procedure includes searching for the BSIC and decoding the BSIC for the first time. The UE may trigger the initial BSIC identification within available idle time slot(s) when the UE is in a dedicated channel (DCH) mode configured for the first RAT.

When a UE is engaged in cell reselection, i.e., determining when to connect to a new cell/base station, various measurements and procedures are executed by the UE and the base station. Generally, cell reselection across different RATs and/or frequency involves mobility procedures across different wireless networks while the UE is in idle mode. Cell reselection may also occur when a UE is in a UTRAN register area paging channel (URA_PCH) mode or cell paging channel (CELL_PCH) mode that permits inter-RAT reselection. Dedicated resources are not allocated to the UE in the CELL_PCH and URA_PCH modes. The UE monitors the paging channel, for CELL_PCH, every time the UE switches to a new cell via cell reselection. The UE transmits cell updates to inform the network of its location changes. For URA_PCH mode, when the UE switches to a cell belonging to the different UTRAN register area (URA), and the UE sends a URA update to inform the network of its location change.

Prior to cell reselection a UE may select and monitor a paging indicator channel (PICH) and a paging channel (PCH) of the cell, monitor for relevant system information, perform measurements of serving (e.g., TD-SCDMA) and neighbor (e.g., LTE and GSM) cells for a cell reselection evaluation procedure, and execute the cell reselection evaluation procedure. The UE also performs measurement for inter-frequency and intra-frequency neighbor cells. Based on the measurement results, potential new/neighbor cells under consideration and the serving cell may be ranked. The UE decides to remain on the serving cell or to perform a cell reselection to a new cell. For example, if cell reselection trigger conditions are met, the UE may decide to connect to the highest ranked neighbor cell.

### Parallel Ranked and Priority Based Cell Reselection

Aspects of the present disclosure are directed to cell reselection that includes both rank based and priority based configurations. A UE determines an expiration of one or more cell reselection timers, e.g., time to trigger (treselection) timer for the rank and/or absolute priority based cell reselection. For example, the UE determines when a first treselection timer expired for a low priority based cell (e.g., neighbor cell) and/or when a second treselection timer expired for a rank based neighbor cell. The UE also determines when a third treselection timer is running, but not expired, for a high priority based neighbor cell. Cell reselection is delayed even when a treselection timer for some cells (e.g., low priority neighbor cells or rank based neighbor cells) expires before a treselection timer for other cells (e.g., higher priority neighbor cells). For example, the UE delays reselection of the rank based neighbor cell and/or the low priority based neighbor cell when a third treselection timer for a high priority based neighbor cell is running, and not expired. In other words, the UE waits for the high priority cell before reselecting to the low priority cell or rank based cell.

In some implementations, cell reselection from a first RAT, such as TD-SCDMA, to a second RAT, such as GSM, is rank based. A network may determine the configuration for reselection of the neighbor cells. Cell reselection according to the rank based configuration may include a ranking of the neighbor cells for a particular UE based on received signal level and/or received signal quality and/or signal strength of the neighbor cells. For example, the received signal level includes a signal strength measurement of the neighbor cells. The received signal quality and/or signal strength includes a signal quality/strength metric of a measured common pilot channel of the neighbor cell.

Other cell reselection from the first RAT to a different RAT, such as LTE, is based on absolute priority. Regarding the absolute priority based cell reselection, the LTE cell may be configured with a higher priority than a serving TD-SCDMA cell. For example, a UE may prefer to connect to a first RAT (e.g., LTE) in certain situations and to a second RAT (e.g., TD-SCDMA) in other situations. The absolute priority of the RATs may be configured by the network and/or the UE. The absolute priority configuration may conform to a standard or a proprietary mechanism.

A time to trigger (TTT) timer for the ranked/absolute priority based configuration starts when an intra and/or inter frequency neighbor cell/RAT meets a cell reselection trigger condition. The treselection timer (e.g., 1-2 seconds) governs when a UE may reselect to a new cell. Thus, even if the UE has determined that a potential neighbor cell meets the cell reselection trigger conditions (e.g., when the neighbor cell is ranked higher than the serving cell), the UE may not be permitted to reselect to the desired neighbor cell until expiration of the treselection timer. For example, if the neighbor cell continues to rank higher than the serving cell upon expiration of the treselection timer, then the UE reselects to the neighbor cell. In some implementations, the cell reselection occurs when the cell reselection trigger condition is consistently satisfied for a reselection time period (e.g., treselection) and the treselection timer expired. The treselection timer may be defined by a serving network.

In these systems, the UE selects the neighbor cell corresponding to the rank based configuration or the absolute priority based configuration based on an order of expiration of their corresponding treselection timers. For example, the UE may select the GSM neighbor cell when the treselection timer for the rank based configuration expires before the treselection timer for the absolute priority based configuration. Similarly, the UE may select the LTE neighbor cell when the treselection timer for the absolute priority based configuration expires before the treselection timer for the rank based configuration. Selecting based on the order of expiration of the treselection timer may result in selection of a neighbor cell with a low priority relative to the available neighbor cells. For example, the UE may select a low priority cell, such as TD-SCDMA, when a higher priority cell, such as LTE, is available for selection.

Aspects of the present disclosure reselect to higher priority neighbor cells even when the treselection timer for a low priority neighbor cell and/or a rank based neighbor cell expires before the treselection timer for the higher priority neighbor cell. For example, if the treselection timer for a low priority neighbor cell or rank based neighbor cell expires and the treselection timer for the high priority based neighbor cell is running, and not expired, the UE does not immediately perform cell reselection. Rather, the UE delays cell reselection until the treselection timer of the higher priority neighbor cell expires. If the high priority neighbor cell expires, the UE reselects to the higher priority neighbor cell.

In some aspects, the treselection timers for the low priority based cell, the rank based cell and/or the high priority based cell continue to run even though cell reselection trigger conditions for the cells are satisfied. In this case, the UE may reselect to the high priority based cell when its timer expired. The treselection timers for the low priority based cell, the rank based cell and the high priority based cell may be independently operated. For example, the timers may have different start times, end times, and reset times.

In case the higher priority cell will not meet cell reselection criteria, the UE continues the treselection timers for the low priority and the rank based neighbor cells when cell reselection triggers for these neighbor cells. Thus, the UE could still reselect to the low priority or rank based cells, if the high priority network does not qualify.

For example, the UE delays cell reselection until the treselection timer for the high priority cell resets due to not meeting the cell reselection trigger conditions. After the treselection timer resets, the UE may select the low priority neighbor cell or the rank based neighbor cell if the treselection timer of the low priority neighbor cell or the rank based configuration cell is running or remains expired. On the other hand, when the treselection timers for the low priority, high priority and rank based neighbor cells are reset as a result of unsatisfied cell reselection trigger conditions, the UE stays on the current serving cell.

Although the description has been with respect to a single low priority timer, a single high priority timer and a single rank based timer, each such timer can actually include multiple timers, one for each cell of that type. For example, there may be multiple low priority based cells, each with its own independent treselection timer. In one aspect of the disclosure, a timer for the high priority based cells resets, when the timer for each of the high priority based cells resets. That is, cell reselection to a low priority or rank based cell does not occur until each of the high priority cells timers has reset. Similarly, the timer for the low priority/ranked based cell resets when the timer for any low priority/ranked based cell resets.

On the other hand, cell reselection to a high priority cell can occur when any one of the high priority timers expires and the trigger conditions are satisfied for that cell.

Similarly, the timer for the low priority/ranked based cell expires when the timer for any low priority/ranked based cell expires.

In one aspect, the timer for the high priority based cells continues to run, when one or more of the timers for the multiple high priority based cells continue to run. Similarly, the timer for the low priority/ranked based cells continues to run, when one or more of the timers for the multiple low priority/ranked based cells continue to run.

The cell reselection trigger condition for the rank based neighbor cell may be satisfied when the rank based neighbor cell is ranked higher than a serving cell based on a relative signal quality and/or signal strength comparison. The cell reselection trigger condition for the high priority based neighbor cell may be satisfied when a signal quality and/or signal strength of the high priority based neighbor cell is above a first absolute threshold indicated by a serving network. The cell reselection trigger condition for the low priority based neighbor cell is satisfied when a signal quality and/or strength of the low priority based neighbor cell is above a first absolute threshold indicated by the serving network and a serving cell signal quality and/or signal strength is below a second absolute threshold indicated by the serving network.

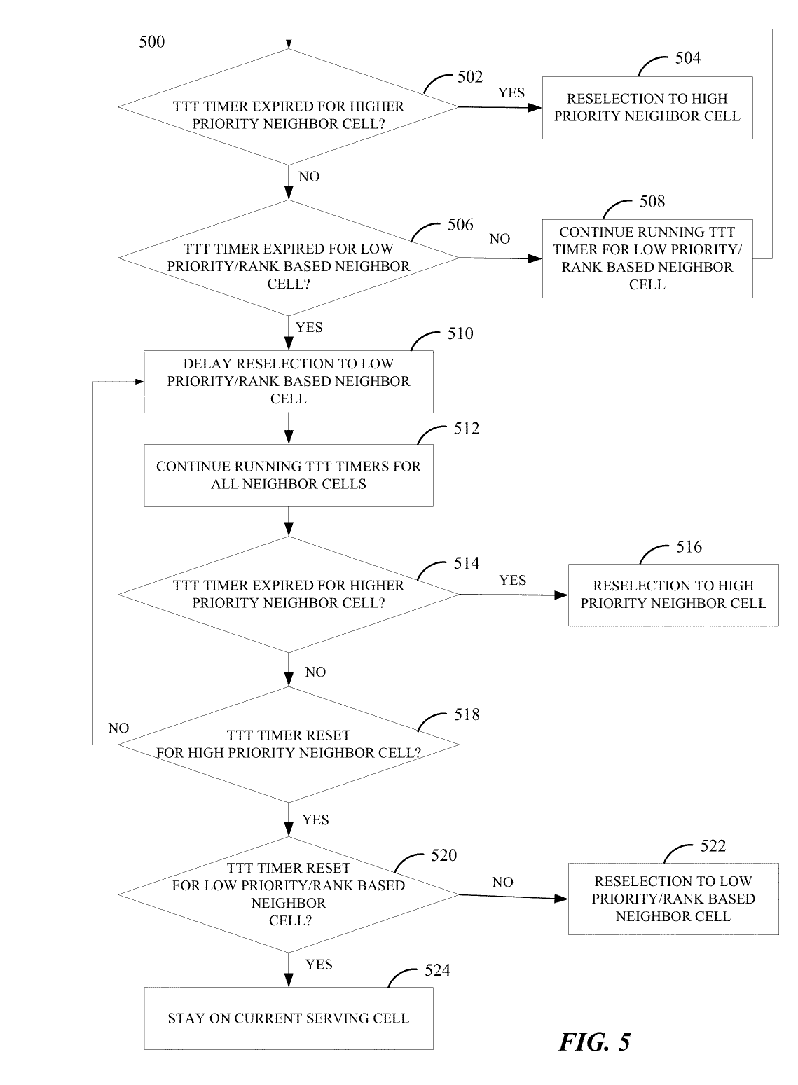

FIG. 5 is a block diagram 500 illustrating a parallel rank and priority based cell reselection method according to one aspect of the present disclosure. At block 502, it is determined whether a treselection timer for the high priority based neighbor cell is running. If so, it is determined whether the high priority treselection timer expired. If the treselection timer for the higher priority neighbor cell expired, the process continues to block 504 where the higher priority neighbor cell is selected when the cell reselection trigger conditions for the high priority based neighbor cell are satisfied. The cell reselection trigger condition for the high priority based neighbor cell is satisfied when the neighbor cell signal quality and/or strength is above a first absolute threshold indicated by a serving network.

If the treselection timer for the high priority based neighbor cell is running, but not expired, the process continues to block 506. At block 506, it is determined whether a treselection timer for a low priority neighbor cell and/or a treselection timer for a rank based neighbor cell expired. It may also be determined whether cell reselection criteria is met. If the treselection timer for the low priority neighbor cell and/or the rank based neighbor cell is not expired, the treselection timer(s) continues to run at block 508. For example, the process continues to run at block 508 when the cell reselection trigger condition for the low priority/ranked based cell is satisfied. The treselection timer for the low priority/ranked based cell may be reset when the cell reselection trigger condition for the low priority/ranked based cell is not satisfied. The process then return to block 502.

If the treselection timer for the low priority neighbor cell and/or the rank based neighbor cell is expired, at block 510, reselection of the low priority neighbor cell and/or the rank based neighbor cell is delayed. At block 512, treselection timers of all of the neighbor cells continue to run. That is, the high priority, low priority and rank based neighbor cell timers run.

At block 514, it is determined whether the treselection timer for the higher priority neighbor cell is expired. If the treselection timer for the higher priority neighbor cell expired (any of the high priority cells if multiple timers are running), the process continues to block 516. At block 516, the higher priority neighbor cell is selected when the cell reselection trigger conditions for the high priority based neighbor cell are satisfied.

Otherwise, the process continues to block 518 where it is determined whether the treselection timer for the higher priority neighbor cell has reset (all of the high priority cells if multiple timers are running). The treselection timer for the higher priority neighbor cell may be reset when the treselection timer expires and the high priority based neighbor cell fails to meet the cell reselection trigger conditions. If the treselection timer for the higher priority neighbor cell is not reset and continues to run, the process continues to block 510.

Otherwise, the process continues to block 520, where it is determined whether the treselection timer for the low priority neighbor cell and/or the rank based neighbor cell reset. For example, the low priority or rank based cell may no longer be a valid candidate for reselection due to radio conditions that changed while waiting for the higher priority cell. If the treselection timer for the low priority neighbor cell and/or the rank based neighbor cell reset, the process continues to block 524. At block 524, the UE stays on the serving cell. For example, the UE stays on a current serving cell when the first, second and third treselection timers have reset because cell reselection trigger conditions are not satisfied.

Otherwise, the process continues to block 522 where the low priority neighbor cell or the rank based neighbor cell is selected. The UE reselects the low priority or rank based priority cell when the treselection timer has reset for the high priority cell because the cell reselection trigger condition is not satisfied, and when the treselection timer for the low priority or rank based neighbor cell has expired. Also, cell reselection trigger conditions are evaluated. For example, the cell reselection trigger condition for the rank based neighbor cell is satisfied when the rank based neighbor cell is ranked higher than a serving cell based on a relative signal quality and/or signal strength comparison. The cell reselection trigger condition for the low priority based neighbor cell is satisfied when the neighbor cell signal quality and/or signal strength is above a first absolute threshold indicated by a serving network and a serving cell signal quality and/or signal strength is below a second absolute threshold indicated by the serving network.

Aspects of the present disclosure allows a user equipment (UE) to reselect a higher priority neighbor cell even when a treselection timer of a low priority cell and/or rank based neighbor cell expires before a treselection timer of the higher priority neighbor cell.

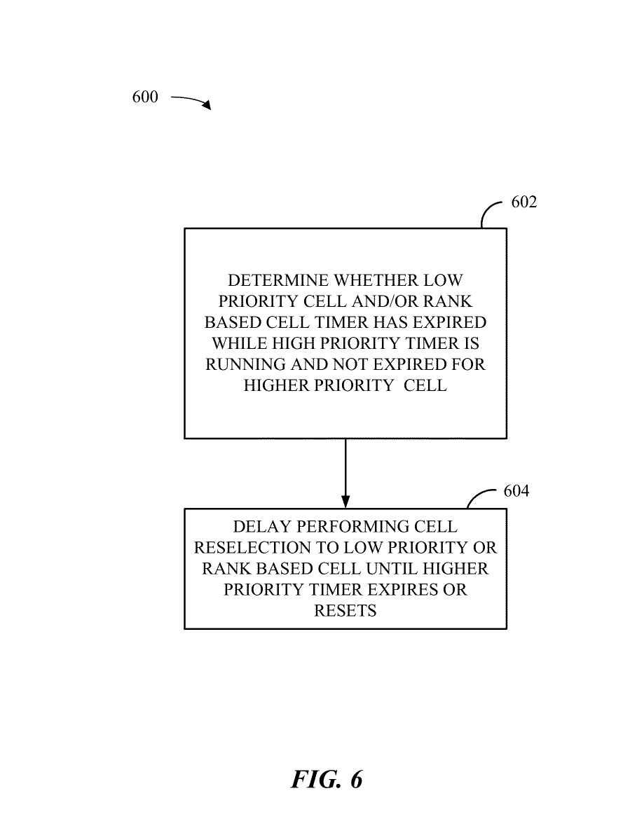

FIG. 6 is a block diagram 600 illustrating a reselection method according to one aspect of the present disclosure. At block 602, a UE determines whether a first treselection timer for a low priority neighbor cell and/or a second treselection timer for a rank based neighbor cell has expired while a third treselection timer is running, but not expired. The third treselection timer is for a high priority based neighbor cell. At block 604, the UE delays performing cell reselection to the low priority or rank based neighbor cell when the high priority treselection timer is still running.

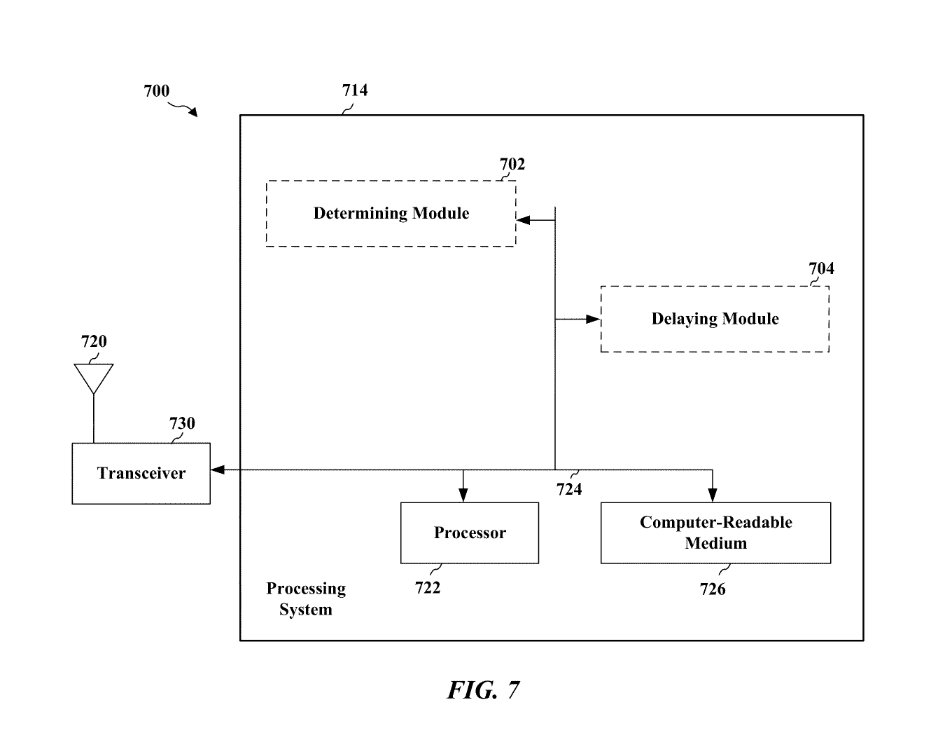

FIG. 7 is a diagram illustrating an example of a hardware implementation for an apparatus 700 employing a parallel reselection system 714. The parallel reselection system 714 may be implemented with a bus architecture, represented generally by the bus 724. The bus 724 may include any number of interconnecting buses and bridges depending on the specific application of the parallel reselection system 714 and the overall design constraints. The bus 724 links together various circuits including one or more processors and/or hardware modules, represented by the processor 722 the modules 702, 704 and the non-transitory computer-readable medium 726. The bus 724 may also link various other circuits such as timing sources, peripherals, voltage regulators, and power management circuits, which are well known in the art, and therefore, will not be described any further.

The apparatus includes a parallel reselection system 714 coupled to a transceiver 730. The transceiver 730 is coupled to one or more antennas 720. The transceiver 730 enables communicating with various other apparatus over a transmission medium. The parallel reselection system 714 includes a processor 722 coupled to a non-transitory computer-readable medium 726. The processor 722 is responsible for general processing, including the execution of software stored on the computer-readable medium 726. The software, when executed by the processor 722, causes the parallel reselection system 714 to perform the various functions described for any particular apparatus. The computer-readable medium 726 may also be used for storing data that is manipulated by the processor 722 when executing software.

The parallel reselection system 714 includes a determining module 702 for determining an expiration of a first treselection timer for a low priority neighbor cell and/or an expiration of a second treselection timer for a rank based neighbor cell when a third treselection timer is running, but not expired. The parallel reselection system 714 includes a delaying module 704 for delaying cell reselection to the low priority or rank based neighbor cell until the high priority cell is evaluated. The modules may be software modules running in the processor 722, resident/stored in the computer readable medium 726, one or more hardware modules coupled to the processor 722, or some combination thereof. The parallel reselection system 714 may be a component of the UE 350 and may include the memory 392, and/or the controller/processor 390.

In one configuration, an apparatus such as a UE is configured for wireless communication including means for determining. In one aspect, the determining means may be the antennas 352/720, the receiver 354, the channel processor 394, the receive processor 370, the controller/processor 390/722, the memory 392, the parallel reselection module 391, the determining module 702, the transceiver 730 and/or the parallel reselection system 714 configured to perform the communicating means. In another aspect, the aforementioned means may be a module or any apparatus configured to perform the functions recited by the aforementioned means.

In one configuration, an apparatus such as a UE is configured for wireless communication including means for delaying. In one aspect, the delaying means may be the antennas 352/720, the receiver 354, the channel processor 394, the receive processor 370, the transmitter 356, the transmit processor 380, the controller/processor 390/722, the memory 392, the parallel reselection module 391, the delaying module 704, the transceiver 730 and/or the parallel reselection system 714 configured to perform the communicating means. In another aspect, the aforementioned means may be a module or any apparatus configured to perform the functions recited by the aforementioned means.

Several aspects of a telecommunications system has been presented with reference to TD-SCDMA, LTE and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining a first timer has expired for a low priority based cell and/or a second timer has expired for a rank based cell while a third timer is running, but not expired, the third timer corresponding to a high priority based cell; and
delaying cell reselection to the low priority based cell or the rank based cell, while the third timer is still running, when a cell reselection trigger condition is satisfied for the low priority based cell and/or rank based cell.

2. The method of claim 1, further comprising,
continuing the first, second and/or third timer when a cell reselection trigger condition for the high priority based cell is not satisfied; and
reselecting to the high priority based cell when the third timer expired for the high priority based cell and the cell reselection trigger condition for the high priority based cell is satisfied.

3. The method of claim 2, in which the cell reselection trigger condition for the high priority based cell is satisfied when a signal quality and/or signal strength of the high priority based cell is above a first absolute threshold indicated by a serving network.

4. The method of claim 1, further comprising reselecting to the rank based cell or the low priority based cell when an unsatisfied cell reselection trigger condition causes the third timer to reset for the high priority based cell, and when the first timer and/or the second timer is running and the cell reselection trigger condition for the rank based cell and/or the low priority based cell is satisfied.

5. The method of claim 4, in which the cell reselection trigger condition for the rank based cell is satisfied when the rank based cell is ranked higher than a serving cell based at least in part on a relative signal quality and/or signal strength comparison.

6. The method of claim 4, in which the cell reselection trigger condition for the low priority based cell is satisfied when a signal quality and/or signal strength of the low priority based cell is above a first absolute threshold indicated by a serving network and a serving cell signal quality and/or signal strength is below a second absolute threshold indicated by the serving network.

7. The method of claim 1, further comprising, staying on a current cell when the first, second and third timers reset as a result of an unsatisfied cell reselection trigger condition.

8. The method of claim 1,
in which the first timer comprises a plurality of first timers, the second timer comprises a plurality of second timers, and the third timer comprises a plurality of third timers,
in which the first timer expires when any one of the plurality of first timers expires, the second timer expires when any one of the plurality of second timers expires, and the third timer expires when any one of the plurality of third timers expires; and
in which the first timer resets when all of the plurality of first timers reset, the second timer resets when all of the plurality of second timers reset, and the third timer resets when all of the plurality of third timers reset.

9. An apparatus for wireless communication, comprising:
means for determining a first timer has expired for a low priority based cell and/or a second timer has expired for a rank based cell while a third timer is running, but not expired, the third timer corresponding to a high priority based cell; and
means for delaying cell reselection to the low priority based cell or the rank based cell, while the third timer is still running, when a cell reselection trigger condition is satisfied for the low priority based cell and/or rank based cell.

10. The apparatus of claim 9, further comprising,
means for continuing the first, second and/or third timer when a cell reselection trigger condition for the high priority based cell is not satisfied; and
means for reselecting to the high priority based cell when the third timer expired for the high priority based cell and the cell reselection trigger condition for the high priority based cell is satisfied.

11. An apparatus for wireless communication, comprising:
a memory; and
at least one processor coupled to the memory and configured:
to determine a first timer has expired for a low priority based cell and/or a second timer has expired for a rank based cell while a third timer is running, but not expired, the third timer corresponding to a high priority based cell; and
to delay cell reselection to the low priority based cell or the rank based cell, while the third timer is still running, when a cell reselection trigger condition is satisfied for the low priority based cell and/or rank based cell.

12. The apparatus of claim 11, in which the at least one processor is further configured,
to continue the first, second and/or third timer when a cell reselection trigger condition for the high priority based cell is not satisfied; and
to reselect to the high priority based cell when the third timer expired for the high priority based cell and the cell reselection trigger condition for the high priority based cell is satisfied.

13. The apparatus of claim 12, in which the cell reselection trigger condition for the high priority based cell is satisfied when a signal quality and/or signal strength of the high priority based cell is above a first absolute threshold indicated by a serving network.

14. The apparatus of claim 11, in which the at least one processor is further configured to reselect to the rank based cell or the low priority based cell when an unsatisfied cell reselection trigger condition causes the third timer to reset for the high priority based cell, and when the first timer and/or the second timer is running and the cell reselection trigger condition for the rank based cell and/or the low priority based cell is satisfied.

15. The apparatus of claim 14, in which the cell reselection trigger condition for the rank based cell is satisfied when the rank based cell is ranked higher than a serving cell based at least in part on a relative signal quality and/or signal strength comparison.

16. The apparatus of claim 14, in which the cell reselection trigger condition for the low priority based cell is satisfied when a signal quality and/or signal strength of the low priority based cell is above a first absolute threshold indicated by a serving network and a serving cell signal quality and/or signal strength is below a second absolute threshold indicated by the serving network.

17. The apparatus of claim 11, in which the at least one processor is further configured to cause a user equipment to stay on a current cell when the first, second and third timers reset as a result of an unsatisfied cell reselection trigger condition.

18. The apparatus of claim 11,
in which the first timer comprises a plurality of first timers, the second timer comprises a plurality of second timers, and the third timer comprises a plurality of third timers,
in which the first timer expires when any one of the plurality of first timers expires, the second timer expires when any one of the plurality of second timers expires, and the third timer expires when any one of the plurality of third timers expires; and
in which the first timer resets when all of the plurality of first timers reset, the second timer resets when all of the plurality of second timers reset, and the third timer resets when all of the plurality of third timers reset.

19. A computer program product for wireless communication, comprising:
a non-transitory computer-readable medium having program code recorded thereon, the program code comprising:
program code to determine a first timer has expired for a low priority based cell and/or a second timer has expired for a rank based cell while a third timer is running, but not expired, the third timer corresponding to a high priority based cell; and
program code to delay cell reselection to the low priority based cell or the rank based cell, while the third timer is still running, when a cell reselection trigger condition is satisfied for the low priority based cell and/or rank based cell.

20. The computer program product of claim 19, in which the program code further comprises:
program code to continue the first, second and/or third timer when a cell reselection trigger condition for the high priority based cell is not satisfied; and
program code to reselect to the high priority based cell when the third timer expired for the high priority based cell and the cell reselection trigger condition for the high priority based cell is satisfied.
